(19) United States
(12) Patent Application Publication
(10) Pub. No.: US 2010/0114878 A1
(43) Pub. Date: May 6, 2010

(54) SELECTIVE TERM WEIGHTING FOR WEB SEARCH BASED ON AUTOMATIC SEMANTIC PARSING

(76) Inventors: Yumao Lu, San Jose, CA (US); Benoit Dumoulin, Palo Alto, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/256,371

(22) Filed: Oct. 22, 2008

(51) Int. Cl. G06F 17/30; G06F 7/00

(52) U.S. Cl. 707/723; 707/E17.014; 707/E17.017

(57) ABSTRACT

A method is provided for selecting relevant documents returned from a search query. When a search engine finds search terms in documents, the document score is based on the frequency of the occurrence of those terms, the category of the term, and the section of the document in which the term is found. Each (category type, document section) pair is assigned a weight that is used to modify the contribution of term frequency. The weights are determined in an offline process using historical data and human validation. Through this empirical process, the weight assignments are made to correlate high relevance scores with documents that humans would find relevant to a search query.

### CROSS REFERENCE TO RELATED APPLICATIONS

This application is related to U.S. patent application Ser. No. 12/252,220 (Docket No. 50269-1076) filed on Oct. 15, 2008 entitled “Automatic Query Concepts Identification And Drifting For Web Search (Query Concepts)” the contents of which are incorporated by this reference in their entirety for all purposes as if fully set forth herein.

### FIELD OF THE INVENTION

The present invention relates to search engines, and in particular, to a technique for ranking search results based on assigning weights to documents.

### BACKGROUND

The approaches described in this section are approaches that could be pursued, but they are not necessarily approaches that have been previously conceived or pursued. Therefore, unless otherwise indicated, it should not be assumed that any of the approaches described in this section qualify as prior art merely by virtue of their inclusion in this section.

With the advent of the Internet and the World Wide Web (“Web”), a wide array of information is instantly accessible to individuals. However, because the Web is expanding at a rapid pace, the ability to find desired Web content is becoming increasingly difficult. Thus, search engines have been developed to assist individuals in finding the Web content they desire. Such search engines are normally accessible via search Web portals, such as the Yahoo! Inc. Web portal.

In order to search for Web content, users typically visit a web portal page. On a web portal page, users submit search queries as phrases representing the scope of the desired content. Based on the search query, the web portal page invokes the search engine to find relevant Web pages containing the Web content and displays the results to the user.

A constant goal of search engines and Web portals is to ensure that the results shown to the user are relevant to the user's query. Relevance is usually determined by analyzing characteristics or features of a document found by the search query and associating a weight with each document feature. Each document is scored based on a function of the weights of its features, where the weight is an indicator of the extent to which the feature contributes to the relevance of the document. The scores are then used to rank the set of documents in relevance order; the documents with the highest score are considered to be the most relevant. This process is also referred to as “assigning a rank,” where the rank is the position of the document in the ranking. A document with a rank of 1 is the first document in the ranking, i.e., the most relevant document.

Features usually considered when analyzing a document are the frequency of search terms in the document and sometimes the frequency of terms related to the search terms. In some approaches, the section of the document in which the search terms or related terms are found influences the weight. However, high frequency of a search term in a single document does not necessarily mean that the document is highly relevant to the search. If the search term is found with high frequency across most of the documents returned in the search, then the importance given to that term is typically lessened, because the presence of that term does not help to distinguish relevance within the set of documents. Attenuating the relevance contribution for frequently found search terms is analogous to filtering out noise to find a signal.

There can be many different ways of scoring a set of documents for assessing relevance to a query. The challenge is determining which attributes of the query terms and the resulting documents correlate well to what humans regard as relevant, determining the weights to assign to those factors (or combination of factors), and validating the choice of weights so that relevance can be automatically calculated based on the determined weights.

Another approach is to track which results have been frequently “clicked” on by users of the Web portal. A Web portal user clicks on a result if the user wishes to visit or select the result for viewing. By clicking the result, the user is redirected from the Web portal to the desired Web page containing Web content. Web portals normally have a way of tracking the number of clicks that a particular result or link has received. Therefore, Web portals may determine which results are relevant by tracking which results have been clicked on the most by Web portal users. However, this approach is also prone to error. For example, although a user may have clicked on a result, the result might not end up being relevant. Specifically, search results displayed to a user are usually in the form of a title and an abstract. Many times, however, the title and abstract are not accurate indications of the actual content of a search result. Thus, although a user may have clicked on a particular result because the result's title and abstract initially seemed relevant, the result may have little or no relevance to the search query.

Yet another approach is to use the frequency of search term found in the document as well as the frequency of related search terms. There are various ways of finding related search terms. One approach is to manually configure related search terms. However, a manual process does not scale to address all terms that could be searched and their related terms. Another approach is to analyze query logs to find terms that were used in queries where the search terms were also used. The problem with this approach is that terms often have different meanings in different contexts. It is difficult to determine automatically the context in which a historical query was made in order to determine accurately the meanings of the search terms.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an example web page with search terms found in document sections of interest.

FIG. 2 is a flow diagram showing the steps of scoring an individual document found in a search query.

FIG. 3 is a flow diagram showing the overview of steps performed using experimental analysis used for assigning weights.

FIG. 4 shows an example matrix with the input values to historical query analysis for determining the weights by performing empirical experiments

FIG. 5 shows the output matrix from historical query analysis used to determine weights.

FIG. 6 is a flow diagram showing the steps performed on each historical query in the experimental analysis used for assigning weights.

FIG. 7 is a block diagram that illustrates a computer system.

### DETAILED DESCRIPTION

### Overview

The approach presented herein may be implemented in conjunction with the system described in U.S. patent application Ser. No. 12/252,220 entitled “Automatic Query Concepts Identification And Drifting For Web Search (Query Concepts).” The system described therein assigns tags to search query terms based on the semantics of the term. Semantics refer to the meaning of the term, and meaning can be derived from categorization. A predictive model, such as a Hidden Markov Model, is used to categorize each of the search terms based on its meaning to the user, and a tag representing the categorization is assigned to each term.

In one embodiment, the semantic tags are categories that may include “business name,” “business category,” and “location.” In another embodiment, semantic tags are categories including “product type” and “product brand.” Examples of search terms that would be tagged with “business name” include “Burger King,” “Sears,” and “Dell.” Examples of search terms that would be tagged with business category include “restaurant,” “retail store,” “computer manufacturer,” and “medical service.” Location tags are assigned to proper names of locations such as “San Jose,” “Calif.,” or “United States” or location types such as “lake,” “mountain,” or “street.”

A fine-grained set of weights is defined for scoring the relevance of documents returned by a search query. Each overall document score is a function of a set of feature scores including at least a set of feature scores for each document section that is measured. In one embodiment, the document is encoded in HTML, and the sections that are scored include the document title, document body, and anchor text. For each combination of (query search term, document section), a weight is assigned based on the combination of tag assigned to the term and the section being scored. In one embodiment, each document section feature score is a function of the frequency of the query search term found in that section and the weight assigned to the combination of the document section and query term tag. Once a feature score is assigned to each (query search term, document section), the scores are combined to derive a single score for the entire document. In one embodiment, the overall document score is determined by adding the feature scores together.

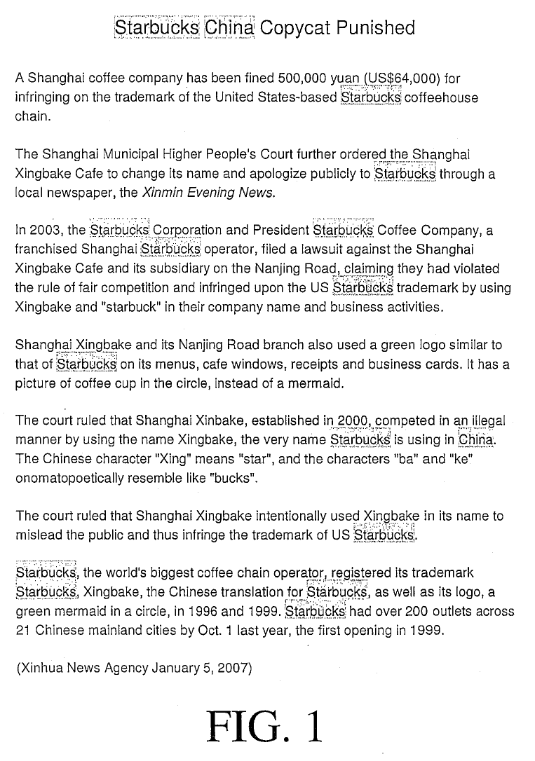

For example, if a user searches for “Starbucks China,” one of the documents found might be entitled, “Starbucks China Copycat Punished ” as seen in FIG. 1. “Starbucks” is assigned a “business name” semantic tag. “China” is assigned a “location” semantic tag. The title includes one instance of each of the search terms. The document body contains 13 instances of “Starbucks” and one instance of “China.” There is no anchor text in the document. The score for this document would be a function of the individual weights assigned to each (search term, document section) pair. Specifically, each weight would be a function of frequency of the term and the weight assigned to the (query search term, document section) pair. If the following weights were assigned: (business name, title)=2, (location, title)=2, (business name, body)=1, and (location, body)=1.5, then in one embodiment the individual feature scores would be computed as:

feature score=frequency of term*weight assigned to (query term tag, section)

fs1=1*(Starbucks, title)=1*2=2

fs2=1*(China, title)=1*2=2

fs3=13*(Starbucks, body)=13*1=13

fs4=1*(China, body)=1*1.5=1.5

If the function to determine the overall score for the document is to add the individual feature scores together, then the overall score for this document is 2+2+13+1.5=18.5. This is just a simple example to illustrate the use of weights and frequency to derive a document score based individual feature scores. A more detailed example is shown below using the (tag, section) weights in conjunction with a standard relevance scoring function.

### Assigning Semantic Tags to Search Terms

After a user enters a search query, the query is parsed into one or more segments, with each segment comprised of a phrase representing a concept. Each phrase is analyzed to determine which semantic tag to assign to that phrase (stated in other words, the phrase is classified according to one of the concept types known to the system). This analysis is conducted using one of a set of well-known sequence tagging algorithms such as Hidden Markov Models (HMM) or the Max Entropy Model. The sequence tagging algorithm takes a sequence of query segments as input and, based on the model, generates a sequence of semantic tags, where the number of generated semantic tags is the same as the number of query segments in the input sequence.

Before any queries can be automatically tagged, an offline process is employed to build the model. In one embodiment, a HMM is used. Sample representative queries are analyzed by an automated, rule-driven process or alternatively by a human editor to perform segmentation and determine a semantic tag to assign each phrase in each sample query. Once constructed, this “training data” is automatically analyzed to construct a set of matrices containing the observational and transitional probabilities, as described next.

Observational probability considers the probability of a particular tag being assigned to a particular phrase in the sequence of tags in the query. Observational probability is calculated as the frequency of assigning a particular tag t to a particular phrase p, divided by the frequency of tag t assigned to any phrase:

$$\frac{f ( p , t )}{f ( t )} .$$

An observational probability matrix is created to store the values computed by this formula. One dimension of the matrix is all the different phrases found in the training data, and the other dimension is all the different semantic tag types. Given a phrase and a tag, the matrix is used to look up the observational probability of assigning the tag to the phrase.

Transitional probability is the probability that a tag tᵢ will follow a sequence of tags {tᵢ₋₂, tᵢ₋₁}in a tag sequence. A matrix is created in which one dimension includes all the different individual semantic tags, and the other dimension is every combination of two semantic tags that could precede a tag. The entries of the matrix store the probability of seeing a sequence {tᵢ₋₂, tᵢ₋₁, tᵢ} across all positions i in the queries of the training data:

$$Transitional probability = \frac{\# times sequence ( {t}_{i - 2} , {t}_{i - 1} , {t}_{i} ) observed}{\# times sequence ( {t}_{i - 2} , {t}_{i - 1} ) observed}$$

In order to use the transitional probability formula in the above example, implicit ‘START’ and ‘END’ tags are added to the query sequence. Thus, a tag sequence of tags A,B,C, and D is treated as “‘START’ A B C D ‘END’.” The probability of finding “A” at the start of the sequence translates to the formula:

$$\frac{f ( START , A )}{f ( START )} ,$$

where f stands for the number of occurrences, or frequency, of observing the sequence. Thus f(START, A) represents the number of times “A” appears at the beginning of a sequence, and f(START) is the number of sequences analyzed (as all sequences have an implicit START tag). The probability of finding the sequence “BCD” anywhere in the sequence is calculated as:

$$\frac{f ( B , C , D )}{f ( B , C )} ,$$

where f(B,D,C) is the number of times the sequence “BCD” is found and f(B,C) is the number of times the sequence “BC” is found at any position within the sequences of training data. The probability of finding “CD” at the end of the sequence is computed as:

$$\frac{f ( C , D , END )}{f ( C , D )} ,$$

where f(C,D,END) is the number of times the sequence “CD” is found at the end of a sequence, and f(C,D) is the number of times the sequence “CD” is found anywhere in a sequence.

The transitional probability reflects the probability of a particular sequence of tags based on the frequency of the particular sequence of tags found in the training data (independent of the content of the current query). The observational probability, in contrast, considers the specific phrases in the current query. The likelihood of a particular tag sequence of length l matching the current query is computed as the transitional probability multiplied by the observational probability. Thus, the formula for the likelihood of a query containing a sequence of words phrases being assigned a sequence of tags is:

$${\prod }_{i = 1}^{l} \frac{f ( {p}_{i} , {t}_{i} )}{f ( t )} * \frac{f ( {t}_{i - 2} , {t}_{i - 1} , {t}_{i} )}{f ( {tk}_{i - 2} , {tk}_{i - 1} )}$$

where l is the number of phrases in the query, with each phrase pᵢ being assigned a semantic tag tᵢ, and (tᵢ₋₂, tᵢ₋₁) is a tag sequence preceding tag tᵢ.

Here is an example of applying the above formula for a query of length 4, computing the likelihood of a tag sequence “A B C D” matching a query sequence of “cat dog bird hamster.” The likelihood L is the product of all the rows in the following table:

| English description | Formula |
|---|---|
| probability of finding “A” at the start of the sequence | $\frac{f ( START , A )}{f ( START )}$ |
| probability of finding “AB” at the start of a sequence among the sequences that start with A. | $\frac{f ( Start , A , B )}{f ( Start , A )}$ |
| probability of finding “ABC” anywhere in a sequence among the sequences that contain “AB” | $\frac{f ( A , B , C )}{f ( A , B )}$ |
| probability of dinging “BCD” anywhere in a sequence among the sequences that contain “BC” | $\frac{f ( B , C , D )}{f ( B , C )}$ |
| probability of finding “CD” at the end of a sequence among the sequences that contain “CD” | $\frac{f ( C , D , END )}{f ( C , D )}$ |
| probability that “cat” was tagged with “A” among sequences that contain a tag “A” | $\frac{f ( “ cat ” , A )}{f ( A )}$ |
| probability that “dog” was tagged with “B” among sequences that contain a tag “B” | $\frac{f ( “ dog ” , B )}{f ( B )}$ |
| probability that “bird” was tagged with “C” among sequences that contain a tag “C” | $\frac{f ( “ bird ” , C )}{f ( C )}$ |
| probability that “hamster” was tagged with “D” among sequences that contain a tag “D” | $\frac{f ( “ hamster ” , D )}{f ( D )}$ |

This same process is carried out for all possible tag sequences (in this example, sequences of length 4), and the tag sequence with the highest L value is the correct sequence to assign the current query, where the phrase in the input sequence is assigned or “tagged with” the semantic tag in the corresponding position of the output sequence. For example, for the input sequence {“cat”, “dog”, “bird”, “hamster”} and an output sequence {A, B, C, D}, “cat” is tagged with A, “dog” is tagged with B, “bird” is tagged with C, and “hamster” is tagged with D.

### Using the Weights Based on Semantic Tags to Score Documents

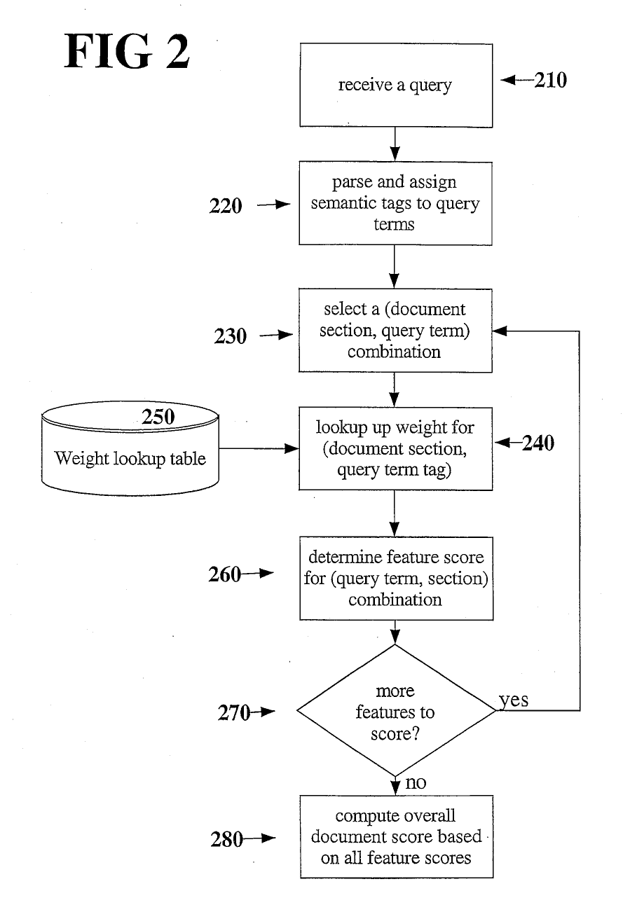

As mentioned earlier, documents returned from a search query are ranked according to their relevance scores and presented to the user in rank order with the highest ranked documented presented first. The relevance score is based on the weights assigned to each combination of semantic tag and document section. FIG. 2 is a flow diagram of how an individual document is scored using the semantic tags and the weights. In Step 210, the query processor receives a search query. In Step 220, the query processor parses the query into individual search terms and assigns semantic tags as described above. At Step 230, the query processor iterates over each combination of search term and document section. For each such combination, in Step 240, the weight is looked up from the weight lookup table 250 corresponding to the combination of query term tag and the document section. In step 260, the feature score is calculated for this combination. In Step 270, the query processor determines whether there are still more (query term, document section) combinations to be processed, and if so, continues iterating. When all combinations have been processed, a document scoring module uses all of the individual feature scores to compute an overall score for the document (Step 280).

### Determining the Weights to Assign to Each Tag, Section Pair

The previous section described how to use the weights assigned to each (tag, section) pair. One of the big challenges in scoring relevance is determining which weight values to assign to which tag/section pair. There are several ways to approach this determination. In one embodiment, empirical experiments are performed using historical query data (e.g., actual queries that users previously submitted to the search engine). Weights are selected to optimize the relevance for those historical queries. If enough historical queries are analyzed, the resulting selected weights should accurately determine relevance of documents returned by future queries.

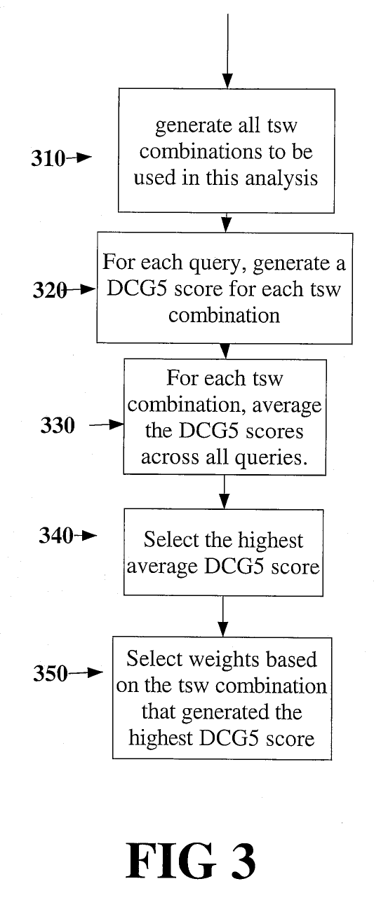

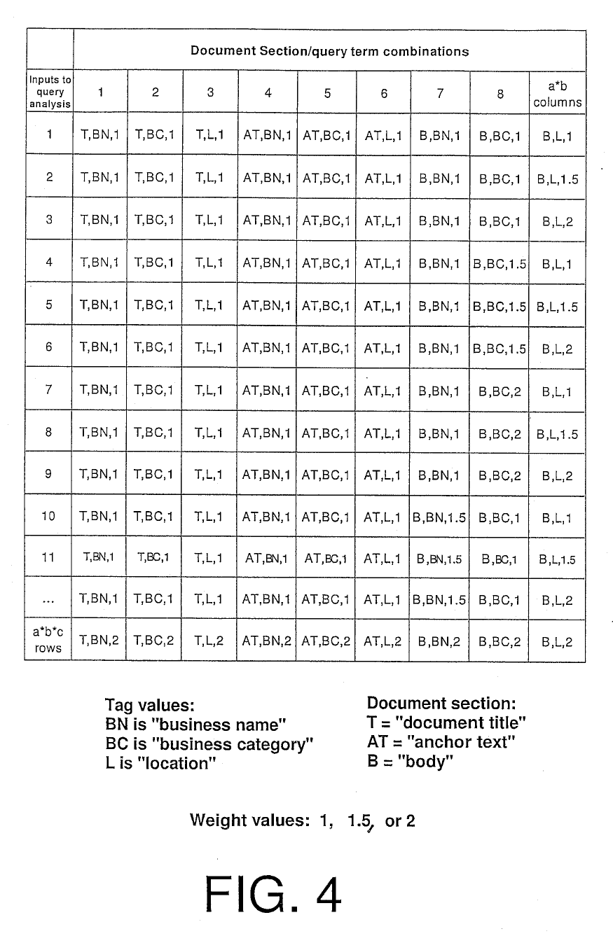

FIG. 3 is a flow diagram showing the overview of the steps for performing empirical experiments for determining the weights to assign to each (semantic tag, document section) combination. In Step 310, all of the potential unique sets of weights are generated. tsw is a short hand representation for a single (tag, document section, weight) combination. FIG. 4 shows an example matrix for determining all tsw combinations. In this example, there are 3 semantic tags (a=3), 3 document sections considered (b=3), and three different weighting values (c=3). Each cell in the matrix holds 1 tsw. Each column represents one unique combination of (semantic tag, document section) of which there are a*b (in this example 3*3=9). An entire row of the matrix is a tsw combination. A tsw combination represents an assignment of a weight value for every unique combination of (semantic tag, document section). For each column, there are c different weight values to assign independently. In this example, there are 3 weight values for each of the columns. Therefore, there are 9*3=27 different tsw combinations represented by the rows of the matrix. Thus, a completed matrix for this example has 9 columns and 27 rows (not all shown for lack of space).

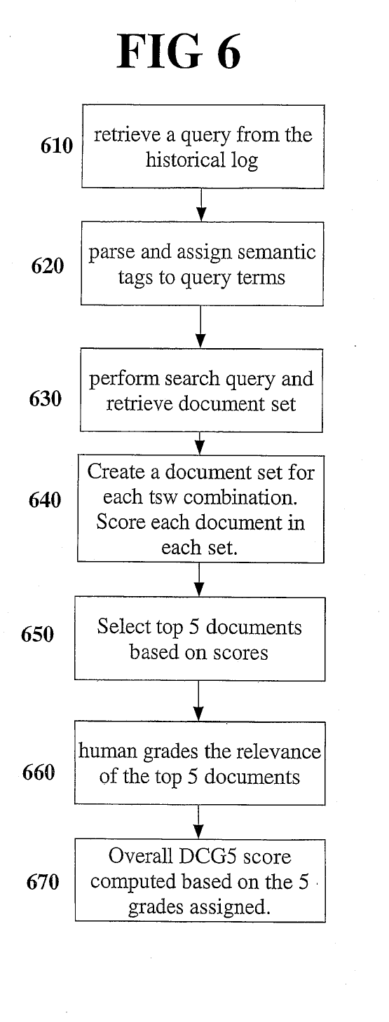

In Step 320, a log analyzer analyzes each query in the historical log, and generates a score for each tsw combination for that query. In one embodiment, the scoring function is a discounted cumulative grade (DCG) function. In one embodiment, a DCG5 function is used. (The significance of the “5” will be explained below). More details about the tsw scoring process is found in the description of FIG. 6 below.

### Using the DCG5 Scores to Select Weights

FIG. 6 shows a flow diagram for how each tsw combination is assigned a score based on human determination of relevance. This process is performed for each combination of query and tsw. The flow diagram shows the process for an individual query. In Step 610, one query is retrieved from a historical log. In Step 620, the query is parsed and assigned semantic tags using the same process as in Step 220 of FIG. 2. In Step 630, the search engine performs the search based on the query terms and creates a document set comprising the documents returned by the search (Step 640). However, because different scoring values will be applied to the document set, there is a document set for each different tsw combination to be used when scoring the documents in the set. Within the document set for a particular tsw combination, each document is scored using the weights indicated in the tsw combination. In Step 650, the documents within the set are ordered according to their scores, and in one embodiment, the top 5 ranked documents are selected for further consideration. These top 5 documents are the “relevant documents” with respect to this combination of query and tsw combination. Because the scoring is different for different tsw combinations, the top 5 documents will differ for different tsw combinations used to score the document set of the same query. At Step 660, rather than inspecting all documents in the results set, a human only inspects the top 5 documents in each set, and assigns a grade of {5,4,3,2, or 1}, corresponding to {“perfect,” “excellent,” “good,” “fair,” or “bad”} respectively, to indicate how relevant the document is to the query. Thus, if the document is perfectly relevant to the query, the human will assign a grade of 5, and if the document has no relevance to the query, the human will assign a grade of 1. In this way, each relevant document is assigned a subscore that will be used to determine an overall score for the tsw combination. Furthermore, the manual effort required to calibrate the weighting system is independent of the size of the result set.

As mentioned earlier, in one embodiment, a DCG5 score is computed based. “5” in “DCG5” score indicates that the top 5 documents are scored. In other embodiments, other numbers of documents are graded in each set and considered in the overall score for assessing the relevance of a tsw combination.

In one embodiment, the DCG5 score for computing the tsw combination score is as follows. First, a score is computed for each individual document of the top 5 documents in a set. The input into the score is the human-assigned grade (G) [1 . . . 5] and the rank (p) [1 . . . 5]. The document given the highest rank by the tsw combination, has a position of 1 and the last document of the top 5 ranking has a position of 5. The score is computed as:

$${\sum }_{i = 1}^{5} \frac{G ( i )}{log ( p + i )}$$

Thus, the highest score possible is given to the top-ranked document that is graded with perfect relevance (5/(log 2)), and the lowest possible score is given to the lowest ranked document given a bad relevance grade (1/(log 6)). The divisor increases for documents in lower positions in the ranking. Thus, scores for lower ranked documents contribute less to the tsw combination score. To compute the overall DCG5 score for a tsw combination, the 5 individual scores for each document with a document set are added together.

### Selecting Weights Based On Highest DCG5 Score

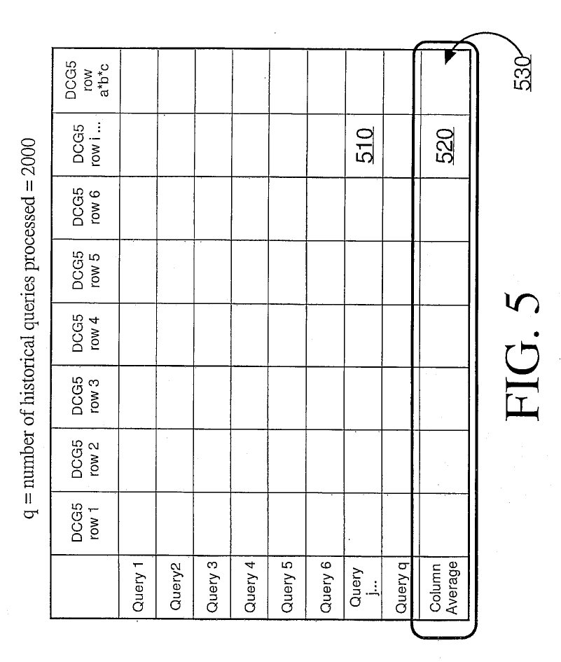

Once the DCG5 scores have been determined for each tsw combination for each historical query, the DCG5 scores for each tsw combination are averaged across all queries. FIG. 5 shows an output matrix of DCG5 scores for the example shown in FIG. 4. There is a column for each tsw combination. In this example, there are 27 tsw combinations, and hence a completed matrix has 27 columns. There is a row for each historical query analyzed. The example analyzed 2000 queries, so a completed matrix would have 2000 rows. Each cell in the matrix contains the DCG5 score for one tsw combination as applied to one historical query. For example, cell 510 contains the value of the DCG5 score for the ith tsw combination when used to score the j^{th} query. In Step 330 of FIG. 3, the DCG5 scores corresponding to a particular tsw are averaged across queries (averages of column values). Cell 520 contains the average of all the DCG5 scores for the i^{th} tsw combination across all queries. In Step 340, to find the optimal assignment of weights across all of the queries, the maximum average value is selected from the row 530. If, for example, cell 520 contained the highest value of any cell in row 530, then the i^{th} tsw combination provides the optimum assignment of weights to (tag, document section) combinations. In Step 350, the values corresponding to the tsw combination that generated the highest average DCG5 score are extracted and placed in the weighting lookup table (250). In the example, the tsw value assignments can be found in the i^{th} row of the matrix in FIG. 4.

### Hardware Overview

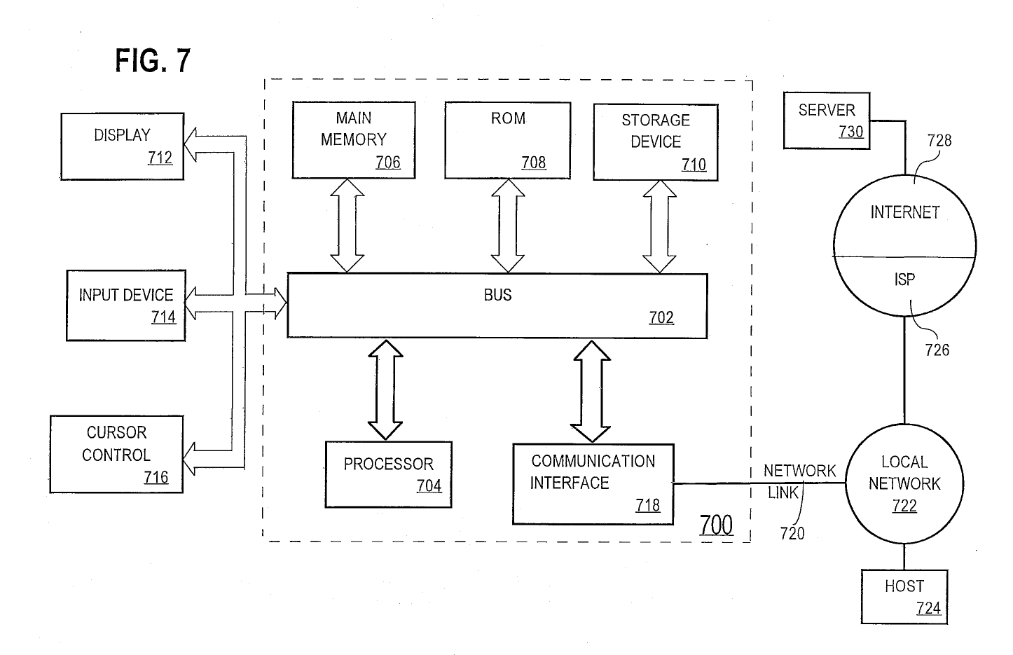

FIG. 7 is a block diagram that illustrates a computer system 700 upon which an embodiment of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 700, various machine-readable media are involved, for example, in providing instructions to processor 704 for execution. Such a medium may take many forms, including but not limited to storage media and transmission media. Storage media includes both non-volatile media and volatile media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising the steps of:
receiving a search query comprising a set of one or more search terms;
assigning to each search term of the set of one or more search terms, a tag that reflects a category to which said each search term belongs;
determining a set of documents based on the set of one or more search terms;
for each document of the set of documents, performing the steps of:
determining a subset of search terms of the set of one or more search terms found in each document section of said each document;
for each combination of
(a) document section in said each document and
(b) search term of the subset of search terms found in said document section, determining a weight based at least on said document section and the tag assigned to said search term;
including the weight in a set of weights associated with said each document; and
ranking said each document based on said set of weights; and
storing in a volatile or non-volatile computer-readable medium the set of documents in rank order.

2 The method of claim 1 wherein the step of ranking comprises:
for each combination of:
(a) document section in said each document and
(b) search term of the subset of search terms found in said document section, determining a feature score;
wherein said feature score is based on:
(a) the frequency of the search term found in the document section and
the weight determined based on said combination.

3. The method of claim 1, wherein a document section is one of title, body, or content in links to other related documents.

4. The method of claim 1, wherein the set of documents are encoded in HTML.

5. The method of claim 4, wherein a document section is included in one of the title, the body, or anchor text.

6. The method of claim 1, wherein the category has a value including one of business name, business category, or location.

7. The method of claim 6, wherein the category has a value further including product name or product category.

8. The method of claim 2, wherein the step of ranking includes adding the values of the feature scores.

9. The method of claim 1, wherein the step of assigning a tag that reflects a category comprises determining the category by using a predictive model.

10. The method of claim 9, wherein the predictive model is a Hidden Markov Model.

11. A method for determining a set of relevant weights for ranking a query result set, the method comprising the steps of:
selecting a set of weights from a plurality of sets of weights, wherein the set of weights assigns one weight value to each combination of document section and semantic tag, and wherein the semantic tag is a category to which a query term belongs;
receiving a search query;
determining a set of documents based on the query;
based on the set of weights, selecting a certain number of relevant documents;
assigning a relevance grade to each relevant document of said relevant documents;
determining a score for the set of weights based on all of the relevance grades assigned to said relevant documents;
associating said score with said set of weights;
choosing from the plurality of sets of weights, a particular set of weights with the highest score of scores associated with sets of weights in the plurality; and
storing said particular set of weights in volatile or non-volatile memory.

12. The method of claim 11, further comprising:
performing the steps for a plurality of queries; and
determining the score for a unique set of weights based on averaging the scores for said unique set of weights across all said plurality of queries.

13. The method of claim 11 wherein the step of selecting a certain number of most relevant documents further comprises determining a rank for each relevant document, wherein determining a score for a set of weights is based on a subscore for each relevant document, wherein the subscore is based on the rank and the relevance grade for said each relevant document.

14. The method of claim 11 wherein the step of determining a score for a set of weights is based on a discounted cumulative grade function.

15. A computer-readable volatile or non-volatile medium storing one or more sequences of instructions, which instructions, when executed by one or more processors, cause the one or more processors to carry out the steps of:
receiving a search query comprising a set of one or more search terms;
assigning to each search term of the set of one or more search terms, a tag that reflects a category to which said each search term belongs;
determining a set of documents based on the set of one or more search terms;
for each document of the set of documents:
determining a subset of search terms of the set of one or more search terms found in each document section of said each document;
for each combination of
(a) document section in said each document and
(b) search term of the subset of search terms found in said document section, determining a weight based at least on said document section and the tag assigned to said search term;
in response to determining the weight, including the weight in a set of weights associated with said each document; and
ranking said each document based on said set of weights; and
storing in a volatile or non-volatile computer-readable medium the set of documents in order of their rank.

16. The computer-readable volatile or non-volatile medium of claim 15 wherein the step of ranking comprises:
for each combination of:
(a) document section in said each document and
(b) search term of the subset of search terms found in said document section, determining a feature score;
wherein said feature score is based on:
(a) the frequency of the search term found in the document section and
(b) the weight determined based on said combination.

17. The computer-readable volatile or non-volatile medium of claim 15, wherein a document section is one of title, body, or content in links to other related documents.

18. The computer-readable volatile or non-volatile medium of claim 15, wherein the set of documents are encoded in HTML.

19. The computer-readable volatile or non-volatile medium of claim 18, wherein a document section is included in one of the title, the body, or anchor text.

20. The computer-readable volatile or non-volatile medium of claim 15, wherein the category has a value including one of business name, business category, or location.

21. The computer-readable volatile or non-volatile medium of claim 20, wherein the category has a value further including product name or product category.

22. The computer-readable volatile or non-volatile medium of claim 16, wherein the step of ranking includes adding the values of the feature scores.

23. The computer-readable volatile or non-volatile medium of claim 15, wherein the step of assigning a tag that reflects a category comprises determining the category by using a predictive model.

24. The computer-readable volatile or non-volatile medium of claim 23, wherein the predictive model is a Hidden Markov Model.

25. A computer-readable volatile or non-volatile medium storing one or more sequences of instructions, which instructions, when executed by one or more processors, cause the one or more processors to carry out steps for determining a set of relevant weights for ranking a query result set, comprising:
selecting a set of weights from a plurality of sets of weights, wherein the set of weights assigns one weight value to each combination of document section and semantic tag, and wherein the semantic tag is a category to which a query term belongs;
receiving a search query;
determining a set of documents based on the query;
based on the set of weights, selecting a certain number of relevant documents;
assigning a relevance grade to each relevant document of said relevant documents;
determining a score for the set of weights based on all of the relevance grades assigned to said relevant documents;
associating said score with said set of weights;
choosing from the plurality of sets of weights, a particular set of weights with the highest score of scores associated with sets of weights in the plurality; and
storing said particular set of weights in volatile or non-volatile memory.

26. The computer-readable volatile or non-volatile medium of claim 25, further comprising:
performing the steps for a plurality of queries; and
determining the score for a unique set of weights based on averaging the scores for said unique set of weights across all said plurality of queries.

27. The computer-readable volatile or non-volatile medium of claim 25 wherein the step of selecting a certain number of most relevant documents further comprises determining a rank for each relevant document,
wherein determining a score for a set of weights is based on a subscore for each relevant document, wherein the subscore is based on the rank and the relevance grade for said each relevant document.

28. The computer-readable volatile or non-volatile medium of claim 25 wherein the step of determining a score for a set of weights is based on a discounted cumulative grade function.
